(19) United States
(12) Patent Application Publication
(10) Pub. No.: US 2014/0122180 A1
(43) Pub. Date: May 1, 2014

(54) METHOD AND SYSTEM FOR ADJUSTING PRODUCT ORDERS DURING REPLENISHMENT SOURCE CHANGES

(71) Applicant: Teradata Corporation, Dayton, OH (US)

(72) Inventor: Tsz Yu Chan, Boston, MA (US)

(73) Assignee: Teradata Corporation, Dayton, OH (US)

(21) Appl. No.: 14/068,331

(22) Filed: Oct. 31, 2013

Related U.S. Application Data
(60) Provisional application No. 61/721,238, filed on Nov. 1, 2012.

(51) Int. Cl. G06Q 30/02

(52) U.S. Cl. CPC G06Q 30/0202
USPC 705/7.31

(57) ABSTRACT

A method and system for adjusting product store order quantities when a retail store is moving a replenishment source from a current distribution center to a new distribution center. The method determines a last delivery date for a last product order from the current distribution center to be placed prior to a product replenishment source change date, and a first delivery date for a first product order from the new distribution center to be placed following the product replenishment source change date; and compares the two delivery dates to determine which delivery will occur first. When the first delivery date for new distribution center predates the last delivery date for the current distribution center, the last product order from the current distribution center is suspended. When the last delivery date for the current distribution center predates the first delivery date for the new distribution center, the quantity of product associated with the last product order from the current distribution center is increased to avoid a product deficiency at the retail store.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/721,238, entitled “METHOD AND SYSTEM FOR ADJUSTING PRODUCT ORDERS DURING REPLENISHMENT SOURCE CHANGES,” filed on Nov. 1, 2012, by David Chan.

### FIELD OF THE INVENTION

The present invention relates to methods and systems for correcting product order forecasts to minimize the effects on a retailer resulting from moving a product replenishment source from one distribution center to another.

### BACKGROUND OF THE INVENTION

Today's competitive business environment demands that retailers be more efficient in managing their inventory levels to reduce costs and yet fulfill demand. To accomplish this, many retailers are developing strong partnerships with their vendors/suppliers to set and deliver common goals. One of the key business objectives both the retailer and vendor are striving to meet is customer satisfaction by having the right merchandise in the right locations at the right time. To that effect it is important that vendor production and deliveries become more efficient. The inability of retailers and suppliers to synchronize the effective distribution of goods through the distribution facilities to the stores has been a major impediment to both maximizing productivity throughout the demand chain and effectively responding to the needs of the consumer.

Aprimo, a division of Teradata Corporation, has developed a suite of analytical applications for the retail business, referred to as Aprimo Demand Chain Management (DCM), which provides retailers with the tools they need for product demand forecasting, planning and replenishment. Aprimo Demand Chain Management assists retailers in accurately forecasting product sales at the store/SKU (Stock Keeping Unit) level to ensure high customer service levels are met, and inventory stock at the store level is optimized and automatically replenished. The individual store product forecasts can thereafter be accumulated and used to determine the appropriate amounts of products to order from a product warehouse or distribution center to meet customer demand. The warehouse or distribution center must in turn order appropriate amounts from suppliers and vendors based on its demand forecast.

When a retail store is moving a replenishment source from one distribution center to another distribution center, some important replenishment attributes, such as review-time (RT) and shipping lead-time (LT), are often impacted by the movement. Described below is a method for adjusting distribution center order forecasts to minimize the effects resulting from moving a replenishment source from one distribution center to another distribution center.

### BRIEF DESCRIPTION OF THE DRAWINGS

FIG. 1 provides an illustration of a product supply/demand chain from a supplier and manufacturer to a retail store and customer.

FIG. 2 is process flow diagram illustrating a synchronized DC/warehouse forecasting and replenishment process.

FIG. 3 provides a high level architecture diagram of a web-based three-tier client-server computer system architecture.

FIG. 4 provides an illustration of a forecasting, planning and replenishment software application suite for the retail industries built upon Teradata Corporation's Teradata. Data Warehouse.

FIG. 5 is a flow diagram illustrating the process for adjusting product orders during replenishment source changes in accordance with the present invention.

FIGS. 6A and 6B provide tables illustrating the process for updating review schedules when moving a product replenishment source from a current distribution center to a new distribution center in accordance with the present invention.

FIG. 7 provides a table illustrating the process for determining cycle time when moving a product replenishment source from a current distribution center to a new distribution center DC2 in accordance with the present invention.

FIG. 8 provides a diagram illustrating the process suspending a product order from a current distribution center when moving a product replenishment source from the current distribution center to a new distribution center in accordance with the present invention.

FIG. 9 provides a diagram illustrating how service level is maintained at a regular level when a product order from a current distribution center is suspended when moving a product replenishment source from the current distribution center to a new distribution center in accordance with the present invention.

FIG. 10 provides a diagram illustrating the addition of days to a product order when a new distribution center has a longer shipping lead time (LT), when moving a product replenishment source from a current distribution center to the new distribution center in accordance with the present invention.

FIG. 11 provides a diagram illustrating how service level is maintained at a minimum level with the addition of days to a product order when a new distribution center has a longer shipping lead time (LT), when moving a product replenishment source from a current distribution center to the new distribution center in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

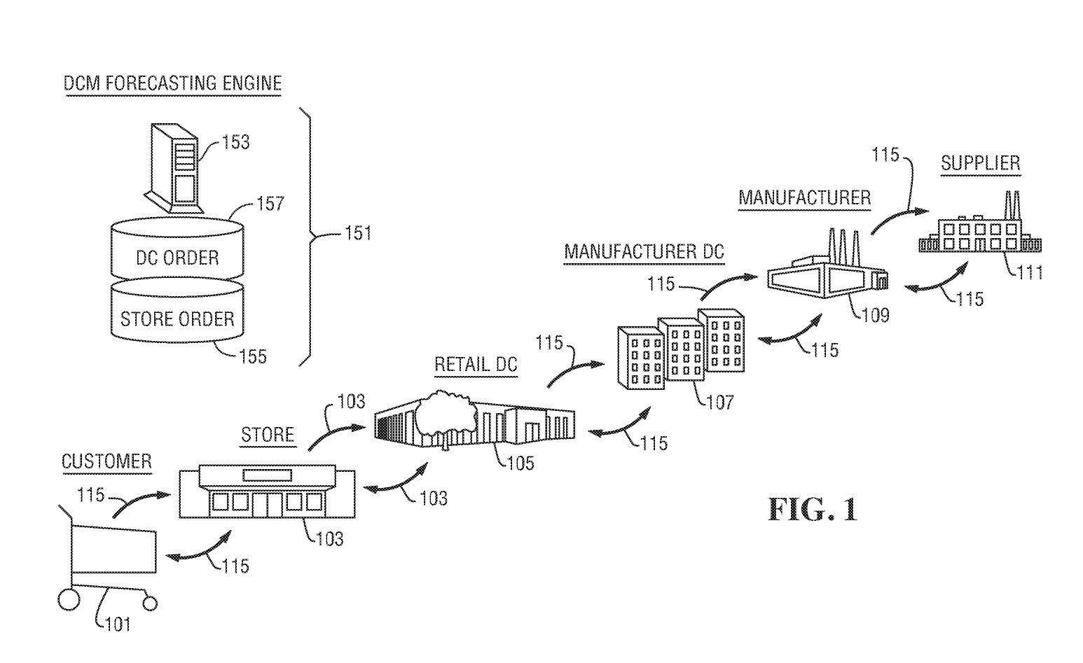

FIG. 1 provides an illustration of a retail demand/supply chain from a customer 101 to a retail store 103, retail distribution center/warehouse 105, manufacturer distribution center/warehouse 107, manufacturer 109 and supplier 111. Arrows 115 are used to illustrate communication between the demand/supply chain entities. The Aprimo Demand Chain Management system, identified by reference numeral 151, includes product demand forecasting, planning and replenishment applications executed on a server 153 to determine store order quantities 155 and distribution center forecasts 157, and provides for the synchronization of the warehouse/distribution center replenishment system with the replenishment ordering system from their supported stores.

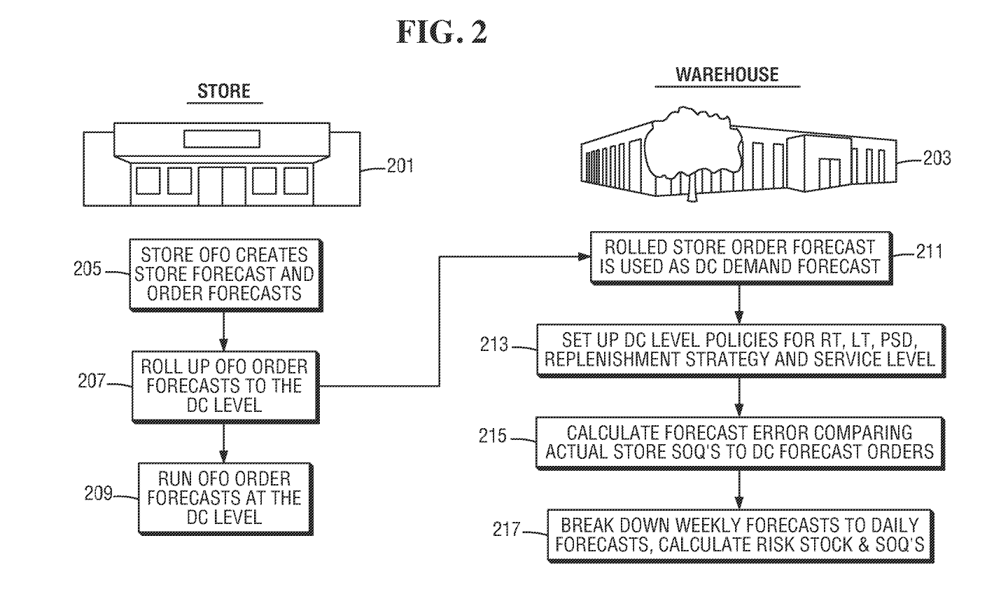

A synchronized DC/warehouse forecasting and replenishment process is illustrated in the process flow diagram of FIG. 2. Beginning at step205, each retail store 201 supplied by warehouse 203 creates a store forecast and order forecast. In step 207, the individual store order forecasts are accumulated to the DC/warehouse level. This rolled-up order forecast is provided to the DC/warehouse 203 for use as the DC/warehouse demand forecast, as shown in step 211.

In step 213, DC/warehouse level policies may be established for RT (Review Time from last time the replenishment system was run), LT (Lead Time from the order being cut to the delivery of product), PSD (Planned Sales Days, the amount of time the Effective Inventory should service the forecast demand), Replenishment Strategy, and Service Level. In step 215, forecast error is calculated comparing actual store suggested order quantities (SOQs) to DC/warehouse forecast orders. Finally, in step 217, weekly forecasts are broken down to determine daily forecasts, calculate safety stock and SOQs. Safety Stock is the statistical risk stock needed to meet a certain service level for a given order quantity. The safety stock is a function of lead times, planned sales days, service level and forecast error.

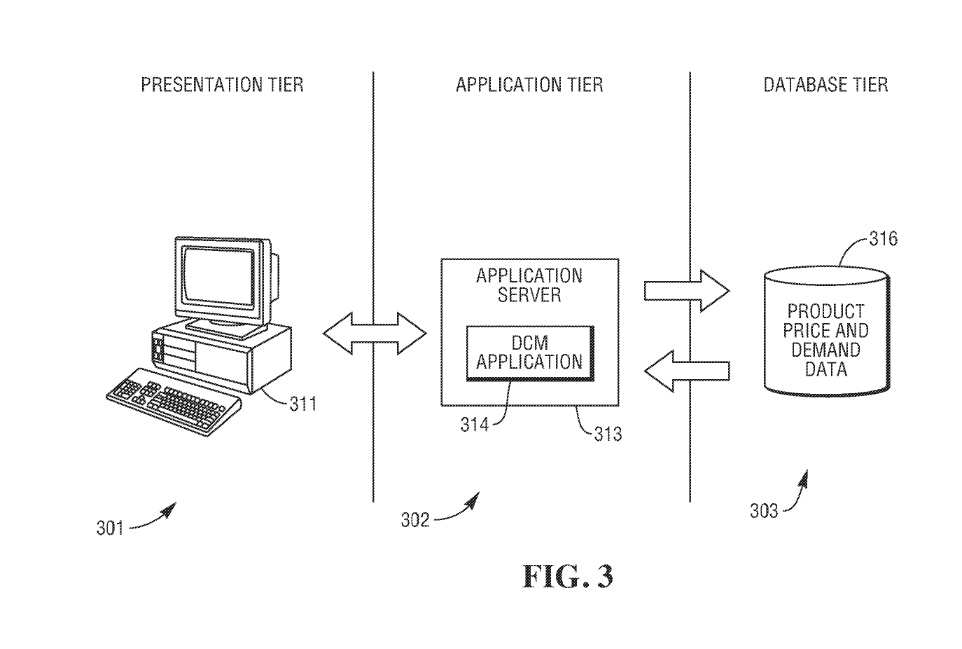

The Aprimo DCM Application Suite may be implemented within a three-tier computer system architecture as illustrated in FIG. 3. The three-tier computer system architecture is a client-server architecture in which the user interface, application logic, and data storage and data access are developed and maintained as independent modules, most often on separate platforms. The three tiers are identified in FIG. 3 as presentation tier 301, application tier 302, and database access tier 303.

Presentation tier 301 includes a PC or workstation 311 and standard graphical user interface enabling user interaction with the DCM application and displaying DCM output results to the user. Application tier 303 includes an application server 153 hosting the DCM software application 314. Database tier 303 includes a database server containing a database 316 of product price and demand data accessed by DCM application 314.

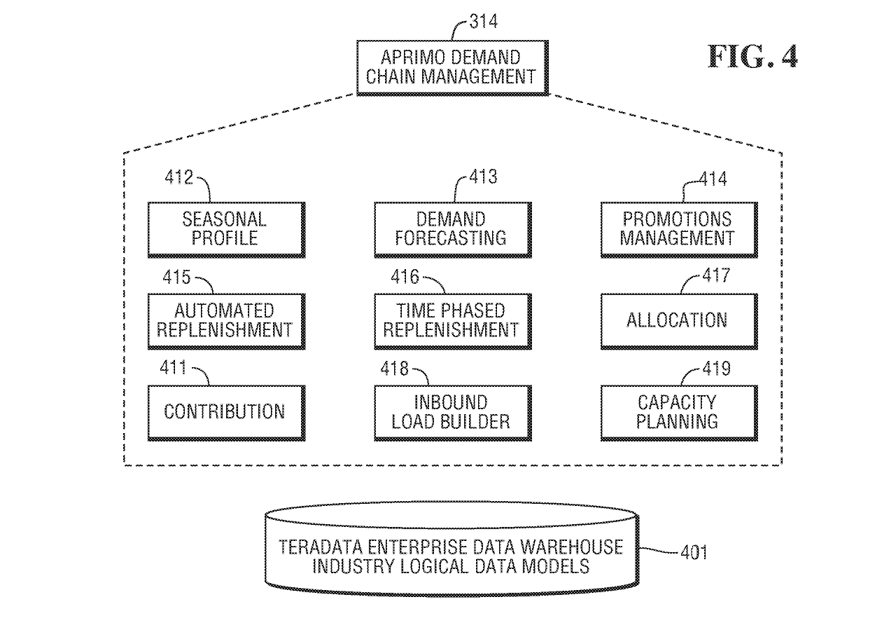

As illustrated in FIG. 4 the Aprimo Demand Chain Management analytical application suite 314 is shown to be part of a data warehouse solution for the retail industries built upon Teradata Corporation's Teradata Data Warehouse 401, using a Teradata Retail Logical Data Model (RLDM). The key modules contained within the Teradata Demand Chain Management application suite 314, are:

Contribution: Contribution module 411 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module 412 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 413 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 414 automatically calculates the precise additional stock needed to meet demand resulting from promotional activity.

Automated Replenishment: Automated Replenishment module 415 provides the retailer with the ability to manage replenishment both at the distribution center and the store levels. The module provides suggested order quantities based on business policies, service levels, forecast error, risk stock, review times, and lead times.

Time Phased Replenishment: Time Phased Replenishment module 416 provides a weekly long-range order forecast that can be shared with vendors to facilitate collaborative planning and order execution. Logistical and ordering constraints such as lead times, review times, service level targets, min/max shelf levels, etc. can be simulated to improve the synchronization of ordering with individual store requirements.

Allocation: The Allocation module 417 uses intelligent forecasting methods to manage pre-allocation, purchase order and distribution center on-hand allocation.

Load Builder: Load Builder module 418 optimizes the inventory deliveries coming from the distribution centers (DCs) and going to the retailer's stores. It enables the retailer to review and optimize planned loads.

Capacity Planning: Capacity Planning module 419 looks at the available throughput of a retailer's supply chain to identify when available capacity will be exceeded.

As stated above, when a store is moving the replenishment source from one distribution center to another distribution center, some important replenishment attributes, including the review-time (RT) and shipping lead-time (LT), are often impacted by the movement. The DCM regular time-phased order calculation algorithm does not consider future-dated RT and LT for the new distribution center when it creates a time-phased order. As a result, planned beginning on-hand (BOH) inventory may fall below any required service level, or the system may not be able to generate an order from the new DC at the beginning of ordering cycles.

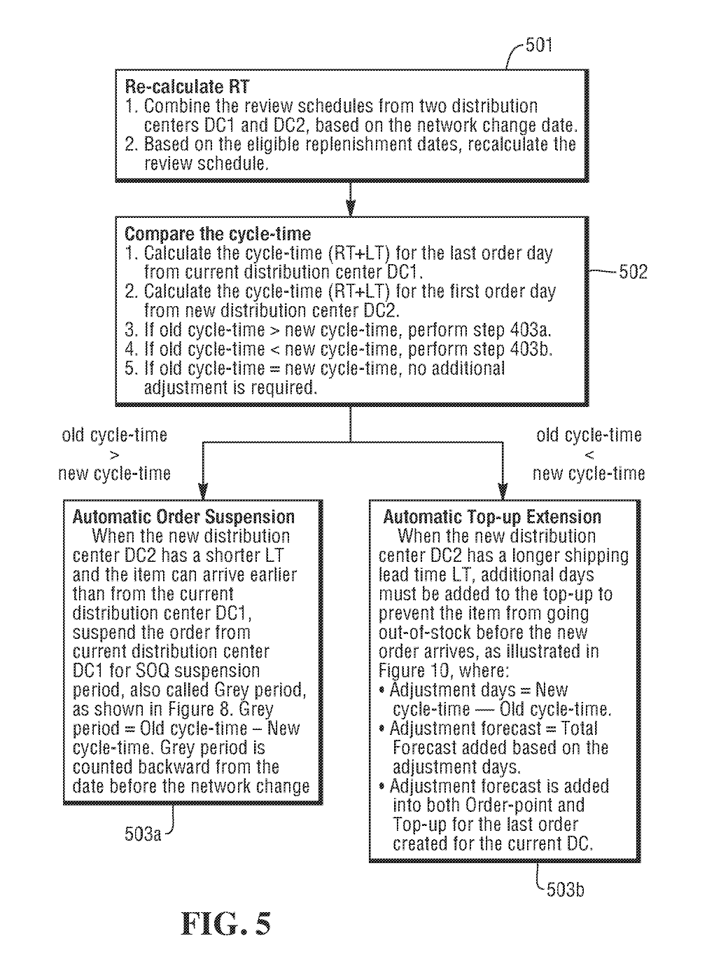

The following additional steps, illustrated in FIG. 5, are executed by the DCM Automated Replenishment module when there is a change in the replenishment network within the replenishment time period (next 28 days or 65 weeks) to minimize the effects resulting from moving a replenishment source.

### Step 501—Re-calculate RT

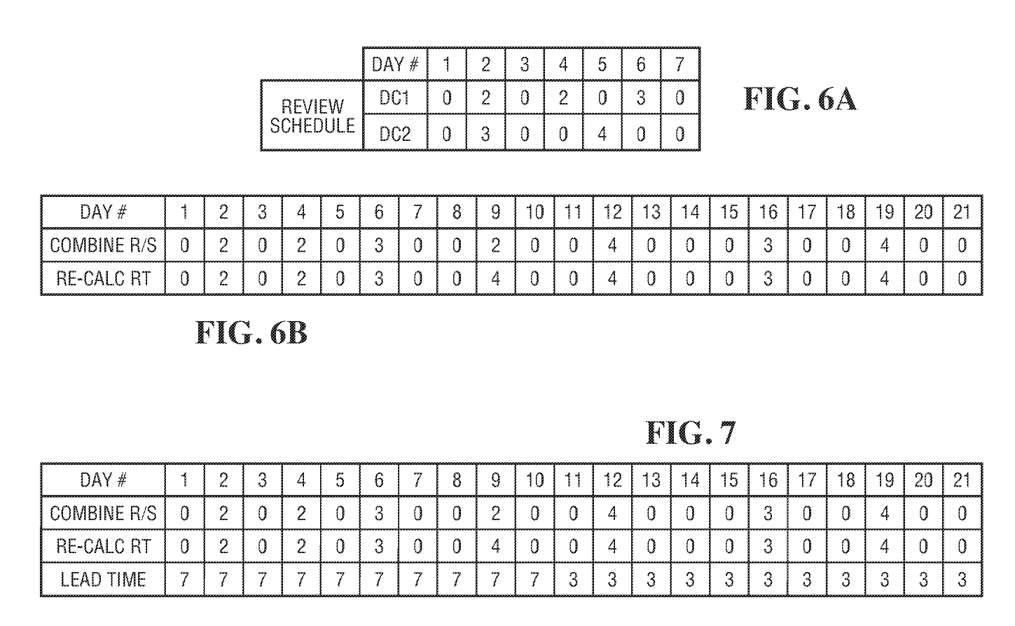

1. Combine the review schedules from two distribution centers, DC1 (current) and DC2 (future), based on the network change date, as shown in FIGS. 6A and 6B.
2. Based on the eligible replenishment dates, recalculate the review schedule.

In the example illustrated, FIG. 6A shows the 7-day review schedules for DC1 and DC2. FIG. 6B shows the combined review schedule and re-calculated review times resulting from the replenishment source moving from current distribution center DC1 to new distribution center DC2 on day # 11. Review Time for day # 9 is changed from 2 days to 4 days.

### Step 502—Compare the Cycle-time

1. Calculate the cycle-time (RT+LT) for the last order day from the current distribution center DC1.
2. Calculate the cycle-time (RT+LT) for the first order day from the new distribution center DC2.
3. If old cycle-time>new cycle-time, perform step 503a.
4. If old cycle-time<new cycle-time, perform step 503b.
5. If old cycle-time=new cycle-time, no additional adjustment is required.

In the example illustrated in FIG. 7, the lead time for DC1, the current distribution center, is 7 days and the lead time for DC2, the new distribution center is 3 days. The old cycle-time, on day 9, is 4+7=11 days. The new cycle-time, on day 12, is 4+3=7 days.

Step 503a—Automatic Order Suspension

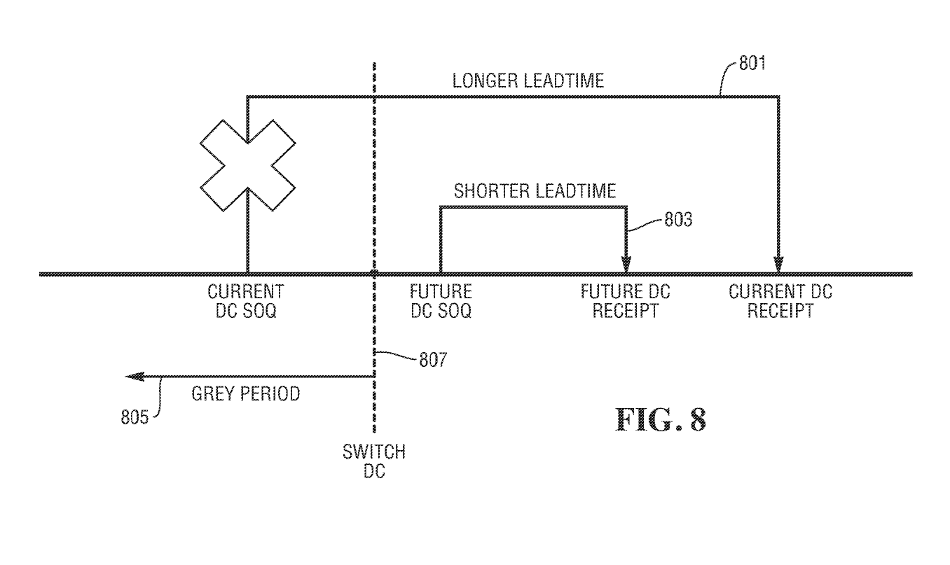

When the new distribution center DC2 has a shorter lead time than the old distribution center DC1 lead time, and the item can arrive earlier than from the current distribution center DC1, DCM Automated Replenishment will suspend the order from current distribution center DC1 as shown in FIG. 8. The lead time for the current distribution center DC1 is shown by reference numeral 801, and the lead time for new distribution center DC2 is shown by reference numeral 803. The SOQ suspension period, also called Grey period 805, is the number of days the system will suspend the order generation, i.e., Grey period days=Old cycle-time−New cycle-time. Grey period is counted backward from the date of the network change 807.

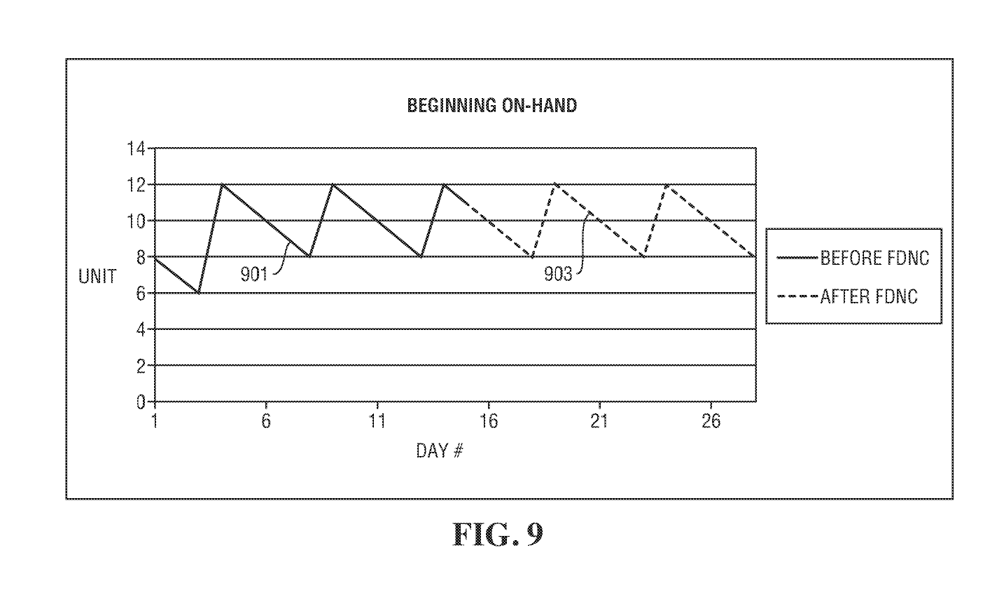

The diagram of FIG. 9 shows that the service level is maintained at a regular level even when the order is suspended from the old distribution center DC1. BOH levels are seen to be the same both prior to the replenishment network change, shown by the solid graph line 901, and following the replenishment network change, as shown by the dashed graph line 903.

Step 503b—Automatic Top-up Extension

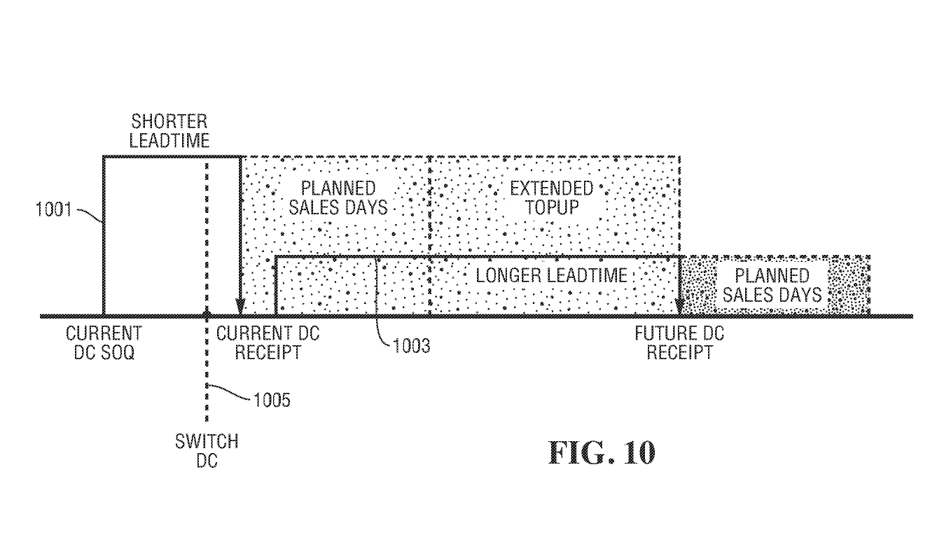

When the new distribution center DC2 has a longer shipping lead time (LT), additional days must be added to the top-up to prevent the item from going out-of-stock before the new order arrives, as illustrated in FIG. 10, where:
The lead time for the current distribution center DC1 is shown by reference numeral 1001, and the lead time for new distribution center DC2 is shown by reference numeral 1003.
The date of the network change is shown by reference numeral 1005.
Adjustment days=New cycle-time−Old cycle-time.
Adjustment forecast=Total Forecast added based on the adjustment days.
Adjustment forecast is added into both Order-point and Top-up for the last order created for the current DC.

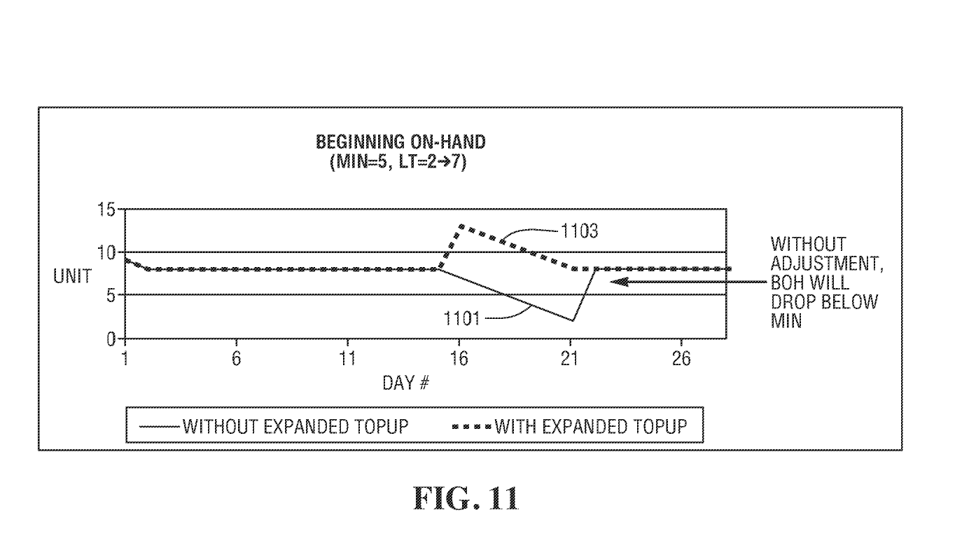

The diagram of FIG. 11 shows that the solution described herein prevents the service level from dropping below the minimum level (Minimum shelf is 5 units). BOH levels are seen to drop below the minimum level between days 16 and 21 without top-up adjustment, shown by solid line 1101, but maintained above the minimum level with top-up adjustment, as shown by dashed line 1103.

The Figures and description of the invention provided above reveal a novel system and method for optimally managing product ordering to minimize the effects resulting from moving a replenishment source from one distribution center to another distribution center. This new ordering forecast algorithm stabilizes the inventory service-level with the planned replenishment network change. Benefits provided by implementing of this solution include:
The solution is applied automatically without any user input. Once the cycle-time is changed, the new algorithm will be activated;
Inventory will be maintained at the minimum level but still be enough to cover the required service level; and
The solution can also reduce the transit time and cost when the new DC has a shorter lead-time.

Instructions of the various software routines discussed herein, are stored on one or more storage modules in the system shown in FIGS. 1 and 3 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching.

What is claimed is:

1. A computer-implemented method for determining order quantities for a product when moving a product replenishment source for a retailer from a current distribution center (DC1) to a new distribution center (DC2), the method comprising the steps of:
determining, by a computer, a last delivery date for a last product order for a quantity of product from said current distribution center DC1, said last product order to be placed prior to a product replenishment source change date;
determining, by said computer, a first delivery date for a first product order for a quantity of product from said new distribution center DC2, said first product order to be placed following the product replenishment source change date;
comparing, by said computer, said last delivery date for said last product order from said current distribution center DC 1 with said first delivery date for said first product order from said new distribution center DC2;
when the first delivery date for said new distribution center DC2 predates the last delivery date for said current distribution center DC1, suspending, by said computer, said last product order from said current distribution center DC1; and
when the last delivery date for said current distribution center DC1 predates the first delivery date for said new distribution center DC2, increasing, by said computer, the quantity of product associated with said last product order from said current distribution center DC1 to avoid a product deficiency at said retailer.

2. A system for determining order quantities for a product when moving a product replenishment source for a retailer from a current distribution center (DC1) to a new distribution center (DC2), the method comprising the steps of:
a computer for:
determining a last delivery date for a last product order for a quantity of product from said current distribution center DC1, said last product order to be placed prior to a product replenishment source change date;
determining a first delivery date for a first product order for a quantity of product from said new distribution center DC2, said first product order to be placed following the product replenishment source change date;
comparing said last delivery date for said last product order from said current distribution center DC 1 with said first delivery date for said first product order from said new distribution center DC2;
when the first delivery date for said new distribution center DC2 predates the last delivery date for said current distribution center DC1, suspending said last product order from said current distribution center DC1; and
when the last delivery date for said current distribution center DC1 predates the first delivery date for said new distribution center DC2, increasing the quantity of product associated with said last product order from said current distribution center DC1 to avoid a product deficiency at said retailer.

3. A non-transitory computer-readable medium having a computer program for determining order quantities for a product when moving a product replenishment source for a retailer from a current distribution center (DC1) to a new distribution center (DC2), the computer program including executable instructions that cause said computer system to:
determining a last delivery date for a last product order for a quantity of product from said current distribution center DC1, said last product order to be placed prior to a product replenishment source change date;
determining a first delivery date for a first product order for a quantity of product from said new distribution center DC2, said first product order to be placed following the product replenishment source change date;
comparing said last delivery date for said last product order from said current distribution center DC1 with said first delivery date for said first product order from said new distribution center DC2;
when the first delivery date for said new distribution center DC2 predates the last delivery date for said current distribution center DC1, suspending said last product order from said current distribution center DC1; and
when the last delivery date for said current distribution center DC1 predates the first delivery date for said new distribution center DC2, increasing the quantity of product associated with said last product order from said current distribution center DC1 to avoid a product deficiency at said retailer.
